(19) United States
(12) Patent Application Publication
(10) Pub. No.: US 2024/0330766 A1
(43) Pub. Date: Oct. 3, 2024

(54) FILTERING FOR MIXING SERVER-BASED AND FEDERATED LEARNING

(71) Applicant: Google LLC, Mountain View, CA (US)

(72) Inventors: Andrew Hard, Seattle, WA (US); Rajiv Mathews, Sunnyvale, CA (US)

(73) Assignee: Google LLC, Mountain View, CA (US)

(21) Appl. No.: 18/609,704

(22) Filed: Mar. 19, 2024

Related U.S. Application Data
(60) Provisional application No. 63/492,750, filed on Mar. 28, 2023.

(51) Int. Cl. G06N 20/00

(52) U.S. Cl. CPC G06N 20/00

(57) ABSTRACT

A method includes receiving, from a client device, a client machine learning (ML) model and obtaining a set of training data including a plurality of training samples. The client ML model is trained locally on the client device. For each respective training sample in the plurality of training samples, the method also includes determining, using the respective training sample, a first loss of the client ML model; determining, using the respective training sample, a second loss of a server machine learning (ML) model; and determining a respective score based on the first loss and the second loss. The method also includes selecting, based on each respective score of each respective training sample in the plurality of training samples, a subset of training samples from the plurality of training samples and training the server ML model using the subset of training samples.

### CROSS-REFERENCE TO RELATED APPLICATIONS

This U.S. patent application claims priority under 35 U.S.C. § 119 (e) to U.S. Provisional Application 63/492,750, filed on Mar. 28, 2023. The disclosure of this prior application is considered part of the disclosure of this application and is hereby incorporated by reference in its entirety.

### TECHNICAL FIELD

This disclosure relates to filtering for mixing server-based and federated learning

### BACKGROUND

Federated learning of machine learning (ML) model(s) is an increasingly popular ML technique for training of ML model(s). In traditional federated learning, a local ML model is stored locally on a client device of a user, and a global ML model, that is a cloud-based counterpart of the local ML model, is stored remotely at a remote system (e.g., a cluster of servers). The client device, using the local ML model, can process user input detected at the client device to generate predicted output and can compare the predicted output to a ground truth output to generate a gradient using supervised learning techniques. Further, the client device can transmit the gradient to the remote system. The remote system can utilize the gradient, and optionally additional gradients generated in a similar manner at additional client devices, to update weights of the global ML model. Further, the remote system can transmit the global ML model, or updated weights of the global ML model, to the client device. The client device can then replace the local ML model with the global ML model, or replace the weights of the local ML model with the updated weights of the global ML model, thereby updating the local ML model.

Notably, the global ML model may be initially trained using a server data set at the remote system and fine-tuned using the federated learning framework in the manner described above. Put another way, the global ML model may be initially trained at the remote server with the server data set until the global ML is usable and then may be subsequently fine-tuned in a privacy-sensitive manner using client data that is more likely to be encountered during inference. However, ML models trained in this may be prone to catastrophic forgetting in that information learned from the server data set in the initial training may be abruptly forgotten when updating the weights of the global ML model based on gradients generated at client devices.

### SUMMARY

One aspect of the disclosure provides a computer-implemented method that when executed on data processing hardware causes the data processing hardware to perform operations that include receiving, from a client device, a client machine learning (ML) model and obtaining a set of training data including a plurality of training samples. The client ML model is trained locally on the client device. For each respective training sample in the plurality of training samples, the operations also include: determining, using the respective training sample, a first loss of the client ML model; determining, using the respective training sample, a second loss of a server machine learning (ML) model; and determining a respective score based on the first loss and the second loss. The operations also include selecting, based on each respective score of each respective training sample in the plurality of training samples, a subset of training samples from the plurality of training samples and training the server ML model using the subset of training samples.

Implementations of the disclosure may include one or more of the following optional features. In some implementations, the client ML model is trained using a local training data set stored locally at the client device. Each respective score may be based on a difference between the first loss and the second loss.

In some examples, selecting the subset of training samples comprises selecting data points from the plurality of training samples with a respective score that satisfies a first threshold. In these examples, selecting the subset of training samples may further include selecting each training sample from the plurality of training samples with a respective score that satisfies a second threshold. Here, the first threshold may include an upper limit threshold and the second threshold may include a lower limit threshold.

In some implementations, the operations also include filtering the set of training samples to remove outlier data points. The first loss of the client ML model may include a reducible holdout loss (RHO-Loss). Additionally or alternatively, the second loss of the server ML model may include a RHO-Loss. The client ML model may be trained locally on the client device using a set of client training data that is different than the set of training data.

Another aspect of the disclosure provides a system that includes data processing hardware and memory hardware storing instructions that when executed on the data processing hardware causes the data processing hardware to perform operations.

The operations include receiving, from a client device, a client machine learning (ML) model and obtaining a set of training data including a plurality of training samples. The client ML model is trained locally on the client device. For each respective training sample in the plurality of training samples, the operations also include: determining, using the respective training sample, a first loss of the client ML model; determining, using the respective training sample, a second loss of a server machine learning (ML) model; and determining a respective score based on the first loss and the second loss. The operations also include selecting, based on each respective score of each respective training sample in the plurality of training samples, a subset of training samples from the plurality of training samples and training the server ML model using the subset of training samples.

Implementations of the disclosure may include one or more of the following optional features. In some implementations, the client ML model is trained using a local training data set stored locally at the client device. Each respective score may be based on a difference between the first loss and the second loss.

In some examples, selecting the subset of training samples comprises selecting data points from the plurality of training samples with a respective score that satisfies a first threshold. In these examples, selecting the subset of training samples may further include selecting each training sample from the plurality of training samples with a respective score that satisfies a second threshold. Here, the first threshold may include an upper limit threshold and the second threshold may include a lower limit threshold.

In some implementations, the operations also include filtering the set of training samples to remove outlier data points. The first loss of the client ML model may include a reducible holdout loss (RHO-Loss). Additionally or alternatively, the second loss of the server ML model may include a RHO-Loss. The client ML model may be trained locally on the client device using a set of client training data that is different than the set of training data.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for filtering for mixing server-based and federated learning.

FIG. 2 is a schematic view of an example training sample filter.

FIG. 3 a flowchart of an example arrangement of operations for a method of filtering for mixing server-based and federated learning.

FIG. 4 is a schematic view of an example computing device that may be used to implement the systems and methods described herein.

Like reference symbols in the various drawings indicate like elements.

### DETAILED DESCRIPTION

Federated learning performs decentralized machine learning (ML) model training and computation on a client device using locally stored data. Federated learning allows for privacy of client data by enabling local ML model training and computation without requiring transmission of potentially sensitive client data to a server. However, ML models trained using federated learning require input from a server-based dataset in addition to the client data to achieve competitive quality ML models. There are many known techniques for combining federated and centralized learning, such as utilizing gradients to update weights at the various models. However, these known techniques have many drawbacks, such as the risk of catastrophic forgetting as well as difficulty in tuning these techniques for various uses due to a large number of parameters that must be separately optimized for each use case.

Implementations herein are directed toward filtering for mixing server-based and federated learning. More specifically, a client machine learning model trained locally at a client device using federated learning may be transmitted to a server. The server may implement the client ML model along with a partially or fully trained server ML model in order to filter data from a set of training data such to select a subset of training data to use to train the server ML model (or a new server ML model). In particular, each training sample from a set of training data may be provided to each of the client ML model and the server ML model, with each ML model producing a respective loss. The client ML model loss and the server ML model loss may be combined or compared to determine a score. The system may select a subset of training samples from the set of training data based on the respective score of each respective training sample of the set of training data.

By filtering the set of training data using both the client ML model and the server ML model, the system of the current disclosure will have many benefits over known techniques for federated learning. In particular, training the server ML model based on a filtered data set will result in quicker training (i.e., faster convergence) as the server ML model will process fewer training samples during training, resulting in time savings as well as the reducing computational resources required to complete training. Further, because the client ML model is used to filter the set of training data, the server ML model trained on the filtered data will converge with the client ML model without the use of gradients and/or without having to tune hyper-parameters. Additionally, the filtering approach can be applied to a number of different machine learning models without modification, which is atypical of other approaches.

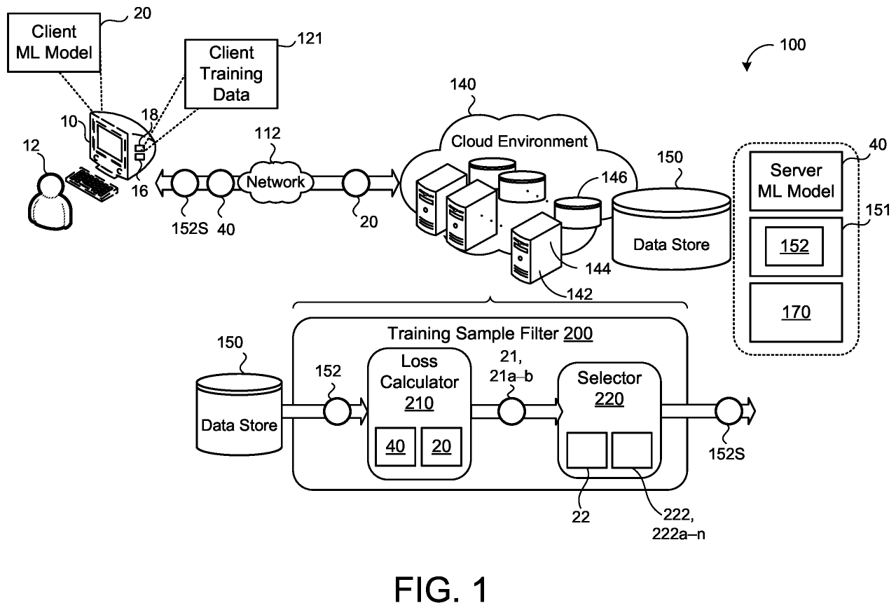

Referring to FIG. 1, in some implementations, an example training sample filtering system 100 includes a remote system 140 (e.g., a high-performance remote server or cluster of high-performance remote servers) in communication with one or more user devices 10 via a network 112. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). The remote system 140 may be configured to train a server machine learning (ML) model 40 using a set of training data 151 including a plurality of training samples 152. A data store 150 (i.e., a remote storage device) may be overlain on the storage resources 146 to allow scalable use of the storage resources 146 by one or more of the clients (e.g., the user device 10) or the computing resources 144. The data store 150 is configured to store the plurality of training samples 152 of the set of training data 151. The data store 150 may also store the server ML model 40.

The remote system 140 is configured to obtain a client machine learning (ML) model 20 from, for example, a client device 10 associated with a respective user 12 via the network 112. The client ML model 20 may be trained using federated learning techniques (i.e., trained locally at the client device 10 using client training data 121 stored locally at the client device 10). In some implementations, the client ML model 20 is a frozen copy (i.e., weights are frozen) or a current version of a client ML model 20 that is being trained on the client device 10. In some implementations, the client device 10 only transmits one or more weights of the client ML model 20 (and/or other relevant portions of the client ML model 20) and not the entire trained client ML model 20. The client device 10 may correspond to any computing device, such as a desktop workstation, a laptop workstation, a vehicular computing device, a wearable computing device, a smart appliance, or a mobile device (i.e., a smart phone). The user device 10 includes computing resources 18 (e.g., data processing hardware) and/or storage resources 16 (e.g., memory hardware).

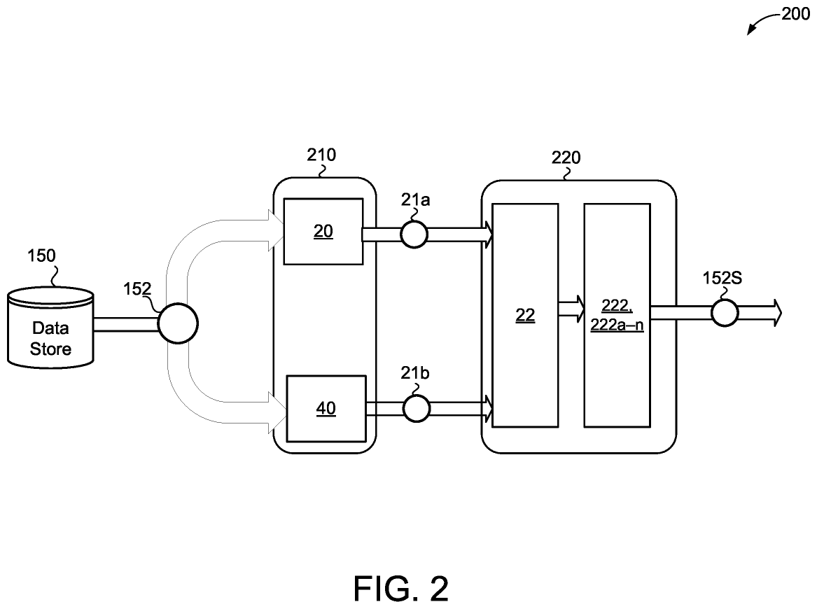

The remote system 140 executes a training sample filter 200 (including a loss calculator 210 and a selector 220) for selecting a subset of training data 152, 152S that includes at least a portion of the plurality of training samples 152 of the set of training data 151. The training sample filter 200, using the loss calculator 210, generates a first loss 21, 21a and a second loss 21, 21b for each respective training sample 152 of the set of training data 151. The training sample filter 200 may also implement the selector 220 to determine, based on the losses 21, a respective score 22 for each training sample 152. In some implementations, the selector 220 compares each score 22 to one or more thresholds 222, 222a-n. The training sample filter 200 may select (from the plurality of training samples 152) the subset of training samples 152S that satisfy one or more of the thresholds 222. In some implementations, the server training engine 170 trains the server ML model 40 using the subset of training samples 152S. The training sample filter 200 is discussed in greater detail below (FIG. 2).

In some implementations, the client ML model 20 that is stored in on-device memory of the client device 10 (e.g., client ML model 20 in the memory hardware 16), can be a local counterpart of the corresponding server ML model 40 (stored at the data store 150 of the remote system 140). In some implementations, the client device 10 and/or the remote system 140 are configured to transmit that ML models 20, 40 between any of the client devices 10 and/or remote system 140. Notably, the server ML model 40 may be initially trained by the remote system 140 (e.g., via a server training engine 170) and based on the set of training data 151 stored at the remote system 140 (e.g., at the data store 150). In some implementations, the server ML model 40 is transmitted to the client device 10 and then further trained using federated learning techniques to generate the client ML model 20 (e.g., further trained on the set of client training data 121 locally on the client device 10) or update/fine-tune the client ML model 20 running on the client device 10. In other words, the client device 10 may store and fine-tune (using local data) the server ML model 40 in corresponding on-device storage 16 as the client ML model in a federated manner as described herein. The client training data 121 may include confidential/sensitive data that is to remain securely stored on the client device 10. In other implementations, the client ML model 20 is initialized locally on the client device 10.

The ML models 20, 40 may include any known or developed machine learning models that can be honed using federated learning techniques. For example, the ML models 20, 40 include a supervised learning model, a reinforcement learning model, a hybrid learning model, a regression model, etc. In some examples, the ML models 20, include various audio-based ML models that are utilized to process audio data generated locally at the client device 10, natural language processing models such as large language models (LLMs), various vision-based ML models that are utilized to process vision data captured/generated locally at the client device 10 and/or any other ML model that may be trained in the federated manner.

For example, assume that the server ML model 40 corresponds to a global hotword detection model. The server ML model 40 is transmitted to the client device 10 to be further trained using federated learning techniques on the set of client training data 121. In this example, the client device 10 may store the global hotword detection model as the client ML model 20 (i.e., a local hotword detection model) that is a local counterpart (i.e., local to the client device 10) of the server hotword detection model (i.e., the server ML model 40). By storing the global hotword detection model locally as the client ML model 40, the client device 10 may optionally replace a prior instance of the local hotword model (or one or more local weights thereof) with the global hotword detection model (or one or more global weights thereof). Further, the client device 10 can process audio data (e.g., as the set of client training data 121), using the local hotword detection model, to generate a prediction of whether the audio data captures a particular word or phrase (e.g., “Assistant”, “Hey Assistant”, etc.) that, when detected, causes an automated assistant executing at least in part at the client device 10 to be invoked as the predicted output(s). The prediction of whether the audio data captures the particular word or phrase can include a binary value of whether the audio data is predicted to include the particular word or phrase, a probability or log likelihood that of whether the audio data is predicted to include the particular word or phrase, and/or other value(s) and/or measure(s).

As another example, assume that a server ML model 40 corresponds to a global hotword free invocation model that is received at the client device 10 from the remote system 140. In this example, the client device 10 may store the global hotword free invocation model as the client ML model 20 that is a local counterpart (i.e., local to the client device 10) of the global hotword detection model in the same or similar manner described with respect to the above example. Further, the client device 10 can process vision data (e.g., as the set of client training data 121), using the local hotword free invocation model, to generate a prediction of whether the vision data captures a particular physical gesture or movement (e.g., lip movement, eye gaze, etc.) that, when detected, causes the automated assistant executing at least in part at the client device to be invoked as the predicted output(s). The prediction of whether the vision data captures the particular physical gesture or movement can include a binary value of whether the vision data is predicted to include the particular physical gesture or movement, a probability or log likelihood that of whether the vision data is predicted to include the particular physical gesture or movement, and/or other value(s) and/or measure(s).

The system of FIG. 1 is presented for illustrative purposes only and is not intended to be limiting. For example, although only a single example of each component is illustrated, the system 100 may include any number of components 10, 140, 150, and 200. Further, although some components are described as being located in a cloud computing environment 140, in some implementations, some or all of the components may be hosted locally on the client device 10. Further, in various implementations, some or all of the components 150 and 200, are hosted locally on client device 110, remotely (such as in the cloud computing environment 140), or some combination thereof. Further, while the implementations described herein are from the perspective of filtering the set of training data 151 to generate the subset of training samples 152S to use to train the server ML model 40, in some implementations, the server ML model 40 is transmitted to the client device 10 such that the server ML model can be used to filter the set of client training data 121 to generate a subset of client training data to train a client ML model 20.

FIG. 2 illustrates an example training sample filter 200. The training sample filter 200 is configured to receive the client ML model 20 and the server ML model 40 (e.g., from the user 12 via the client device 10, remote servers, or other modules of the remote system 140). The training sample filter 200, in some implementations, includes a loss calculator 210 that determines and/or estimates a respective loss 21 using each of the client ML model 20 and the server ML model 40. In other words, for each respective training sample 152, the loss calculator determines the first loss 21a for the client ML model 20 and the second loss 21b for the server ML model 40. For each respective training sample 152, each respective loss 21a-b indicates a discrepancy between the outputs of the ML models 20, 40 when provided the respective training sample 152. In some implementations, the losses 21a and 21b are calculated as a reducible holdout loss selection (RHO-loss) according to the equation:

$$arg max ( x , y ) ϵ {B}_{t} L [ y \vert x ; {D}_{t} ] - L [ y \vert x ; {D}_{ho} ] \qquad [ 1 ]$$

Here, L[y|x; Dₜ] represents the training loss and L[y|x; Dₕₒ] represents the irreducible holdout loss.

In some examples, a small loss 21 indicates that the output of the respective ML model 20, 40 is relatively close to the target output (i.e., the training label) of the respective training sample 152. On the other hand, a large loss 21 may indicate that the output of the respective ML model 20, 40 is far off from the target output (i.e., the training label) of the respective training sample 152.

The loss calculator 210 transmits the losses 21 to the selector 220. The selector 220 may determine a respective score 22 for each respective training sample 152 based on the respective losses 21. In some implementations, the score 22 is based on a difference between the first loss 21a and the second loss 21b. In other implementations, the score is based on a sum of the first loss 21a and the second loss 21b.

In some implementations, the selector 220 selects one or more training samples 152 for inclusion in the subset of training samples 152S based on the one or more thresholds 222 and the respective score 22. For example, the thresholds can include an upper limit threshold 222, 222a, a lower limit threshold 222, 222b, or any other appropriate threshold 222 for selecting training samples 152 for the subset of training samples 152S. The upper limit threshold 222a may include a value that is greater than a value of the lower limit threshold 222b. In some examples, the selector 220 organizes or sorts the training samples 152 of the set of training data 151 in order based on the respective score 22. The selector 220 may eliminate (i.e., not select) any training samples 152 with a respective score 22 that exceeds the upper limit threshold 222a and/or eliminate any training samples 152 with a respective score 22 that is below the lower limit threshold 222b. Accordingly, the remaining training samples 152 (i.e., the training samples 152 that are selected for the subset of training samples 152S) satisfy each of the thresholds 222.

In some implementations, a predetermined number of training samples 152 must be selected for the subset of training samples 152S. Accordingly, the selector 220 may only select an appropriate number of training samples 152 such that a size of the subset of training samples 152S matches the predetermined number. For example, if the set of training data 151 includes 1000 training samples 152 and the predetermined number for the subset of training samples 152S is 100, the selector 220 may not select the 450 training samples 152 having the lowest respective scores 22 as well not select the 450 training samples 152 having the highest respective scores 22. In some examples, when selecting the subset of training samples 152S, the selector 220 selects the training samples 152 with the greatest scores 22 (e.g., the training samples 152 with respective scores 22 in the top 10 percentile). In other implementations, the selector 220 selects the training samples 152 from a randomly pre-sampled set of the set of training data 151.

In some implementations, the training sample filter 200 selects the subset of training samples 152S (using a frozen state or previous version of the server ML model 40) concurrently while the server training engine 170 trains a current iteration of the server ML model 40. For example, one or more computing devices of the remote system 140 execute the server training engine 170 to train the server ML model 40 while, in parallel, one or more other computing devices of the remote system 140 execute the training sample filter 200. Once the training sample filter 200 selects the subset of training samples 152S, the subset of training samples 152S are transmitted to the server training engine 170 for use in training the server ML model 40. Further, in other implementations the remote system 140 transmits the subset of training samples 152S to the client device 10 to further train the client ML model 20.

In some additional implementations, the training sample filter 200 is implemented on the client device 10. In these implementations, the remote system 140 transmits the server ML model 40 to the client device 10. The training sample filter 200 may then implement the client ML model 20 and the server ML model 40 to filter the set of client training data 121 locally on the client device 10 using the loss calculator 210 and the selector 220, as described above. The training sample filter 200 accordingly filters the set of client training data 121 to a subset of client training data for the client device 10 to use to train the client ML model 20 (e.g., using federated learning).

Filtering training data 151 as described herein can expedite training of an ML model (e.g., client ML model 20 or server ML model 40) by removing noisy data (e.g., mislabeled or ambiguous data), redundant data (e.g., data that is already learned), and/or non-relevant data (e.g., outlier data). Noisy data may refer to training samples 152 with a high or low score 22. Noisy data may include ambiguous or incorrect labels which lead to a large loss 21. Because of the poor labels, these training samples 152 may not be helpful in training ML models 20, 40. A redundant data point refers to a training sample 152 that the ML models 20, 40 have already learned. In turn, such redundant data points have low training loss 21 meaning that the output of the ML model 20, 40 is nearly identical to the label (i.e., target output) of the respective training sample 152. Non-relevant data refers to training samples 152 that have a high training loss 21 because they have data that is not representative of the set of training data 151. Removing non-relevant data helps training ML models 20, 40, as such non-relevant data can skew the ML models 20, 40 by adjusting weights inappropriately to compensate for the large associated loss 21. By removing noisy, redundant, and/or non-relevant training samples 152 from the set of training data 151, the resulting filtered subset of training samples 152S may include training samples 152 that are related to data that is especially learnable, worth learning, and/or not yet learned by the ML model 20, 40.

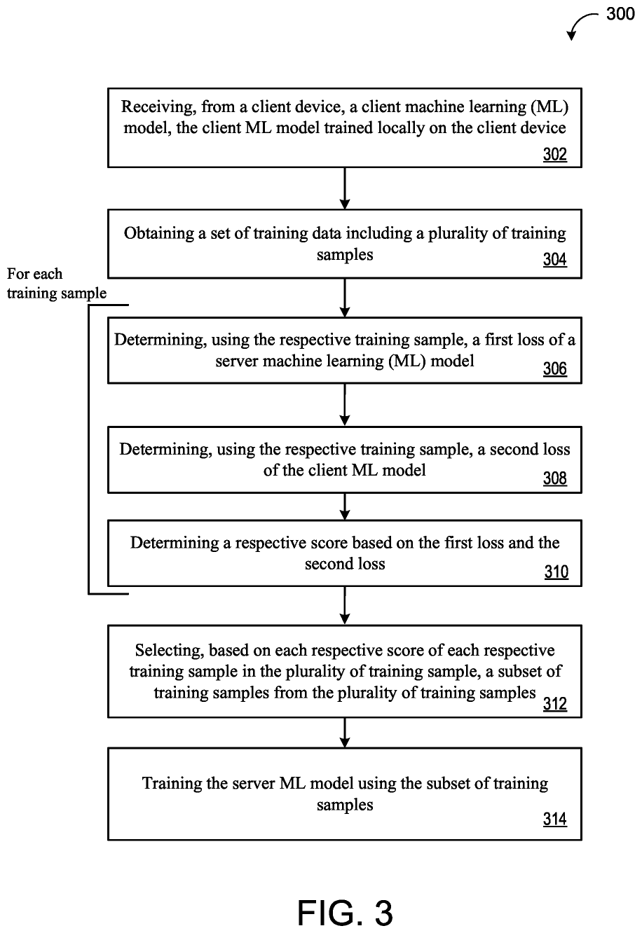

FIG. 3 is a flowchart of an exemplary arrangement of operations for a method 300 of filtering for mixing server-based and federated learning. The method 300 may execute on the data processing hardware 142 of the remote system 140 of the training filtering system 100 of FIG. 1. At operation 302, the method 300 includes receiving, from a client device 10, a client machine learning (ML) model 20, the client ML model trained locally on the client device 10. At operation 304, the method 300 includes obtaining a set of training data 151 that includes a plurality of training samples 152.

The method 300 performs operations 306-310 for each respective training sample 152 in the plurality of training samples 152. At operation 306, the method 300 includes determining, using the respective training sample 152, a first loss 21, 21a of the client ML model 20. At operation 308, the method 300 includes determining, using the respective training sample 152, a second loss 21, 21b of a server machine learning (ML) model 40. At operation 310, the method 300 includes determining a respective score 22 based on the first loss 21a and the second loss 21b.

At operation 312, the method 300 includes selecting, based on each respective score 22 of each respective training sample 152 in the plurality of training samples 152, a subset of training samples 152S from the plurality of training samples 152. At operation 314, the method 300 includes training the server ML model 40 using the subset of training samples 152S.

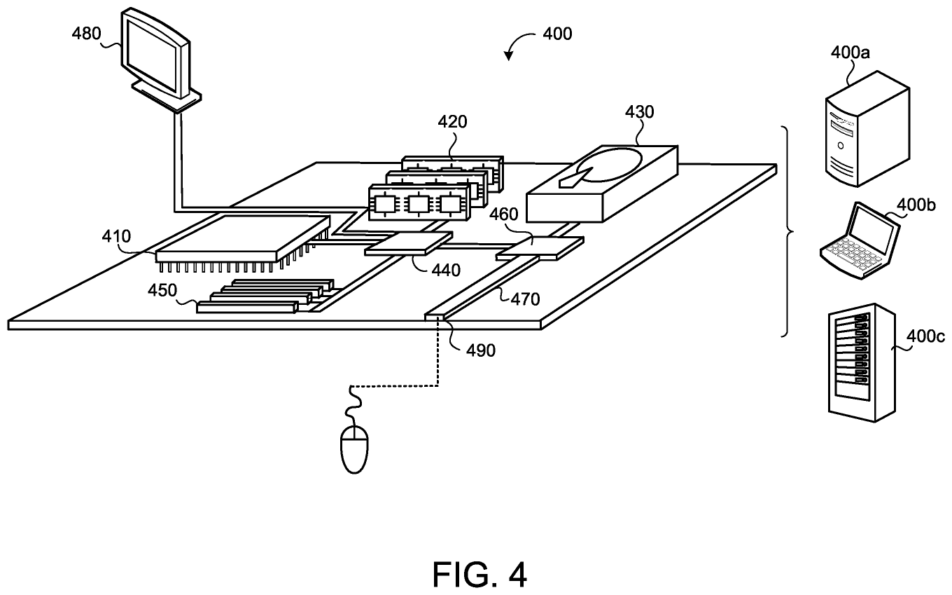

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer.

Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
receiving, from a client device, a client machine learning (ML) model, the client ML model trained locally on the client device;
obtaining a set of training data comprising a plurality of training samples;
for each respective training sample in the plurality of training samples:
determining, using the respective training sample, a first loss of the client ML model;
determining, using the respective training sample, a second loss of a server machine learning (ML) model; and
determining a respective score based on the first loss and the second loss;
selecting, based on each respective score of each respective training sample in the plurality of training samples, a subset of training samples from the plurality of training samples; and
training the server ML model using the subset of training samples.

2. The method of claim 1, wherein the client ML model is trained using a local training data set stored locally at the client device.

3. The method of claim 1, wherein each respective score is based on a difference between the first loss and the second loss.

4. The method of claim 1, wherein selecting the subset of training samples comprises selecting data points from the plurality of training samples with a respective score that satisfies a first threshold.

5. The method of claim 4, wherein selecting the subset of training samples further comprises selecting each training sample from the plurality of training samples with a respective score that satisfies a second threshold.

6. The method of claim 5, wherein the first threshold is an upper limit threshold and the second threshold is a lower limit threshold.

7. The method of claim 1, wherein the operations further comprise filtering the set of training samples to remove outlier data points.

8. The method of claim 1, wherein the first loss of the client ML model comprises a reducible holdout loss (RHO-Loss).

9. The method of claim 1, wherein the second loss of the server ML model comprises a reducible holdout loss (RHO-Loss).

10. The method of claim 1, wherein the client ML model is trained locally on the client device using a set of client training data that is different than the set of training data.

11. A system comprising:
data processing hardware; and
memory hardware in communication with the data processing hardware, the memory hardware storing instructions that when executed on the data processing hardware cause the data processing hardware to perform operations comprising:
receiving, from a client device, a client machine learning (ML) model, the client ML model trained locally on the client device;
obtaining a set of training data comprising a plurality of training samples;
for each respective training sample in the plurality of training samples:
determining, using the respective training sample, a first loss of the client ML model;
determining, using the respective training sample, a second loss of a server machine learning (ML) model; and
determining a respective score based on the first loss and the second loss;
selecting, based on each respective score of each respective training sample in the plurality of training samples, a subset of training samples from the plurality of training samples; and
training the server ML model using the subset of training samples.

12. The system of claim 11, wherein the client ML model is trained using a local training data set stored locally at the client device.

13. The system of claim 11, wherein each respective score is based on a difference between the first loss and the second loss.

14. The system of claim 11, wherein selecting the subset of training samples comprises selecting data points from the plurality of training samples with a respective score that satisfies a first threshold.

15. The system of claim 14, wherein selecting the subset of training samples further comprises selecting each training sample from the plurality of training samples with a respective score that satisfies a second threshold.

16. The system of claim 15, wherein the first threshold is an upper limit threshold and the second threshold is a lower limit threshold.

17. The system of claim 11, wherein the operations further comprise filtering the set of training samples to remove outlier data points.

18. The system of claim 11, wherein the first loss of the client ML model comprises a reducible holdout loss (RHO-Loss).

19. The system of claim 11, wherein the second loss of the server ML model comprises a reducible holdout loss (RHO-Loss).

20. The system of claim 11, wherein the client ML model is trained locally on the client device using a set of client training data that is different than the set of training data.
